(19) United States
(12) Patent Application Publication
(10) Pub. No.: US 2022/0393809 A1
(43) Pub. Date: Dec. 8, 2022

(54) METHOD FOR PARAMETER CONFIGURATION OF FREQUENCY MODULATION

(71) Applicant: ZTE Corporation, Shenzhen (CN)

(72) Inventors: Bo Gao, Shenzhen (CN); Zhaohua Lu, Shenzhen (CN); Meng Mei, Shenzhen (CN); Chuangxin Jiang, Shenzhen (CN); Shujuan Zhang, Shenzhen (CN)

(73) Assignee: ZTE Corporation, Shenzhen (CN)

(21) Appl. No.: 17/819,163

(22) Filed: Aug. 11, 2022

Related U.S. Application Data
(63) Continuation of application No. PCT/CN2020/074743, filed on Feb. 11, 2020.

(51) Int. Cl. H04L 5/00; H04W 72/04

(52) U.S. Cl. CPC H04L 5/001; H04W 72/042; H04W 72/0453; H04W 72/0413

(57) ABSTRACT

Wireless communication method, systems and devices for parameter configuration of frequency modulation. The wireless communication method comprises transmitting an uplink (UL) signal, wherein, based on an event associated with a first downlink (DL) reference signal (RS), the UL signal is modulated according to a specific carrier frequency.

### PRIORITY

This application claims priority as a Continuation of PCT/CN2020/074743, filed on Feb. 11, 2020, entitled “METHOD FOR PARAMETER CONFIGURATION OF FREQUENCY MODULATION”, published as WO 2021/093197 A1, the entirety of which is incorporated herein by reference.

### TECHNICAL FIELD

This document is directed generally to wireless communications.

### BACKGROUND

High speed train (HST) scenario becomes an essential new radio (NR) 5G deployment scenario, especially in Asia, with the development of global HST networks. Considering the extremely fast speed of the HST and a limited coverage of a single NR-transition point (NR-TRP) station, multi-TRPs and remote radio head (RRH) techniques are widely used for establishing a single frequency network (SFN), in which, from user equipment (UE) perspective, the mobility between different TRPs (RRHs) is transparent (i.e. potential complexity of handover functionality shall be avoided). From system perspective, there is a narrow cell along an HST railway.

### SUMMARY

This document relates to methods, systems, and devices for parameter configuration of frequency modulation. The present disclosure relates to a wireless communication method for use in a wireless terminal. The wireless communication method comprises: transmitting an uplink, UL, signal, wherein, based on an event associated with a first downlink, DL, reference signal, RS, the UL signal is modulated according to a specific carrier frequency.

Various embodiments may implement the following features:

In some embodiments, the event is one of being indicated that the UL signal does not refer to the first DL RS or refers to a local carrier frequency, or the first DL RS is not configured, and the specific carrier frequency is the local carrier frequency or a carrier frequency of the wireless terminal.

In some embodiments, the event is that the UL signal is associated to the first DL RS, and the specific carrier frequency is a carrier frequency of the first DL RS.

In some embodiments, the first DL RS is received no later than or before transmitting the UL signal or a command scheduling the UL signal.

In some embodiments, at least one sample of the first DL RS is received no later than or before transmitting the UL signal or a command scheduling transmitting the UL signal.

In some embodiments, the specific carrier frequency is applied according to an applicable time that is determined according to a command associated with the first DL RS, a command associated with a parameter state comprising the first DL RS, or at least one sample of the first DL RS.

In some embodiments, the UL signal is transmitted no earlier than or after the applicable time and the specific carrier frequency is a carrier frequency of the first DL RS.

In some embodiments, the UL signal is transmitted no later than or before the applicable time; and the specific carrier frequency is not determined according to the first DL RS or is determined according to the most recently used carrier frequency.

In some embodiments, the first DL RS is determined according to a first parameter state applied to the UL signal.

In some embodiments, the first DL RS is a reference RS in the first parameter state and relates to at least one of a carrier frequency or a Doppler shift.

In some embodiments, the first DL RS is associated with a QCL type parameter comprising at least one of a carrier frequency or a Doppler shift.

In some embodiments, the first DL RS is associated with a QCL-TYPEA, a QCL-TYPEB or a QCL-TYPEC.

In some embodiments, the first DL RS is configured by a radio resource control, RRC, signaling or activated by a media access control control element, MAC-CE, command.

In some embodiments, the RRC signaling or the MAC-CE command is applied for a cell or a carrier component, and wherein the UL signal is in the cell or the carrier component.

In some embodiments, the first DL RS is configured in at least one of physical UL control channel, PUCCH, configuration signaling, a physical UL shared channel, PUSCH, configuration signaling or a sounding reference signal, SRS, configuration signaling, or is configured for at least one of a PUCCH resource, a PUCCH resource group, a PUCCH resource set an SRS resource or an SRS resource set.

In some embodiments, the first DL RS is a channel state information, CSI, RS used for tracking or a tracking RS, TRS.

In some embodiments, the first DL RS is configured with a physical cell index and a reference RS with regard to a QCL type parameter.

In some embodiments, the first DL RS is configured with a second parameter state, and wherein the second parameter state comprises a physical cell index and a reference RS with regard to a QCL type parameter.

In some embodiments, a parameter state comprising the first DL RS is activated with a third parameter state which comprises a reference RS with regard to a QCL type parameter.

In some embodiments, a QCL assumption of the first DL RS is determined according to the third parameter state, or the third parameter state is applied to the first DL RS.

In some embodiments, the parameter state comprising the first DL RS is activated for a physical DL control channel, PDCCH, a physical DL shared channel, PDSCH, a physical UL control channel, PUCCH, or a physical UL shared channel, PUSCH.

In some embodiments, the parameter state comprising the first DL RS is determined based on at least one of: a hybrid automatic repeat request acknowledge, HARQ-Ack, message corresponding a PDSCH carrying a MAC-CE which activates the parameter state comprising the first DL RS, a RS transmission occasion, or DL control information triggering the transmission of the first DL RS.

In some embodiments, the QCL type parameter comprises a Doppler shift.

In some embodiments, the reference RS is a synchronization signal block, SSB.

In some embodiments, a frequency offset parameter is configured or activated for the UL signal, for the first DL RS or for a parameter state comprising the first DL RS, and wherein the UL signal is further modulated according to the frequency offset parameter.

In some embodiments, the frequency offset parameter is associated with a time stamp or a time-domain step.

In some embodiments, the first DL RS or a parameter state comprising the first DL RS is associated with a time stamp or a time-domain step.

In some embodiments, the time stamp or the time-domain step is configured by an RRC signaling or a MAC-CE command.

In some embodiments, the parameter state is a quasi-co-location, QCL, state, a transmission configuration indicator, TCI, state, spatial relation information, a RS, a reference RS, a physical random access channel, PRACH, a spatial filter or a pre-coding.

The present disclosure relates to a wireless communication method for use in a wireless network node. The wireless communication method comprises: transmitting, to a wireless terminal, a first downlink, DL, reference signal, RS, and receiving, from the wireless terminal, an uplink, UL, signal, wherein, based on an event associated with the first DL RS, the UL signal is modulated according to a specific carrier frequency.

Various embodiments may implement the following features:

In some embodiments, the event is one of being indicated that the UL signal does not refer to the first DL RS or refers to a local carrier frequency, or the first DL RS is not configured, and the specific carrier frequency is the local carrier frequency or a carrier frequency of the wireless terminal.

In some embodiments, the event is that the UL signal is associated to the first DL RS, and the specific carrier frequency is a carrier frequency of the first DL RS.

In some embodiments, the first DL RS is transmitted no later than or before receiving the UL signal or a command scheduling the UL signal.

In some embodiments, at least one sample of the first DL RS is transmitted no later than or before receiving the UL signal or a command scheduling the UL signal.

In some embodiments, the specific carrier frequency is applied according to an applicable time that is determined according to a command associated with the first DL RS, a command associated with a parameter state comprising the first DL RS, or at least one sample of the first DL RS.

In some embodiments, the UL signal is received no earlier than or after the applicable time; and the specific carrier frequency is a carrier frequency of the first DL RS.

In some embodiments, the UL signal is received no later than or before the applicable time; and the specific carrier frequency is not determined according to the first DL RS or is determined according to the most recently used carrier frequency.

In some embodiments, the first DL RS is determined according to a first parameter state applied to the UL signal.

In some embodiments, the first DL RS is a reference RS in the first parameter state and relates to at least one of a carrier frequency or a Doppler shift.

In some embodiments, the first DL RS is associated with a QCL type parameter comprising at least one of a carrier frequency or a Doppler shift.

In some embodiments, the first DL RS is associated with a QCL-TYPEA, a QCL-TYPEB or a QCL-TYPEC.

In some embodiments, the first DL RS is configured by a radio resource control, RRC, signaling or activated by a media access control control element, MAC-CE, command.

In some embodiments, the RRC signaling or the MAC-CE command is applied for a cell or a carrier component, and wherein the UL signal is in the cell or the carrier component.

In some embodiments, the first DL RS is configured in at least one of physical UL control channel, PUCCH, configuration signaling, a physical UL shared channel, PUSCH, configuration signaling or a sounding reference signal, SRS, configuration signaling, or is configured for at least one of a PUCCH resource, a PUCCH resource group, a PUCCH resource set an SRS resource or an SRS resource set.

In some embodiments, the first DL RS is a channel state information, CSI, RS used for tracking or a tracking RS, TRS.

In some embodiments, the first DL RS is configured with a physical cell index and a reference RS with regard to a QCL type parameter.

In some embodiments, the first DL RS is configured with a second parameter state, and wherein the second parameter state comprises a physical cell index and a reference RS with regard to a QCL type parameter.

In some embodiments, a parameter state comprising the first DL RS is activated with a third parameter state which comprises a reference RS with regard to a QCL type parameter.

In some embodiments, a QCL assumption of the first DL RS is determined according to the third parameter state, or the third parameter state is applied to the first DL RS.

In some embodiments, the parameter state comprising the first DL RS is activated for a physical DL control channel, PDCCH, a physical DL shared channel, PDSCH, a physical UL control channel, PUCCH, or a physical UL shared channel, PUSCH.

In some embodiments, the parameter state comprising the first DL RS is determined based on at least one of: a hybrid automatic repeat request acknowledge, HARQ-Ack, message corresponding a PDSCH carrying a MAC-CE which activates the parameter state comprising the first DL RS, a RS transmission occasion, or DL control information triggering the transmission of the first DL RS.

In some embodiments, the QCL type parameter comprises a Doppler shift.

In some embodiments, the reference RS is a synchronization signal block, SSB.

In some embodiments, a frequency offset parameter is configured or activated for the UL signal, for the first DL RS or for a parameter state comprising the first DL RS, and wherein the UL signal is further modulated according to the frequency offset parameter.

In some embodiments, the frequency offset parameter is associated with a time stamp or a time-domain step.

In some embodiments, the first DL RS or a parameter state comprising the first DL RS is associated with a time stamp or a time-domain step.

In some embodiments, the time stamp or the time-domain step is configured by an RRC signaling or a MAC-CE command.

In some embodiments, the parameter state is a quasi-co-location, QCL, state, a transmission configuration indicator, TCI, state, spatial relation information, a RS, a reference RS, a physical random access channel, PRACH, a spatial filter or a pre-coding.

The present disclosure relates to a wireless communication method for use in a wireless terminal. The wireless communication method comprises: receiving a downlink, DL, signal, wherein the DL signal is associated with at least one fourth parameter state, and wherein at least one of the at least one fourth parameter state comprises at least one second DL reference signal, RS, with regard to a first quasi-co-location, QCL, type parameter.

Various embodiments may implement the following features:

In some embodiments, the first QCL type parameter comprises a Doppler shift.

In some embodiments, a frequency offset parameter between the DL signal and the at least one second DL RS is configured by an RRC signaling or a MAC-CE command.

In some embodiments, at least one third DL RS, which is in the at least one fourth parameter state and is not associated with a UL signal, is ignored with regard to the first QCL type parameter.

In some embodiments, the second DL RS is associated with the UL signal.

In some embodiments, the first QCL type parameter is QCL-TYPEA, QCL-TYPEB or QCL-TYPEC.

In some embodiments, one of the at least one fourth parameter state further comprises a third DL RS with regard to a second QCL type parameter, wherein the second QCL type parameter does not comprise a Doppler shift and comprises a Doppler spread.

In some embodiments, the second QCL type parameter further comprises at least one of an average delay or a delay spread.

In some embodiments, the first QCL type parameter comprises the Doppler spread and the Doppler shift.

In some embodiments, the second DL RS is configured with a physical cell index and a reference RS with regard to a third QCL type parameter.

In some embodiments, the second DL RS is configured with a fifth parameter state, and wherein the fifth parameter state comprises a physical cell index and a reference RS with regard to a third QCL type parameter.

In some embodiments, a parameter state comprising the second DL RS is activated with a sixth parameter state which comprises a reference RS with regard to a third QCL type parameter.

In some embodiments, a QCL assumption of the second DL RS is determined according to the sixth parameter state, or the sixth parameter state is applied to the second DL RS.

In some embodiments, the parameter state comprising the second DL RS is activated for a physical DL control channel, PDCCH, a physical DL shared channel, PDSCH, a physical UL control channel, PUCCH, or a physical UL shared channel, PUSCH.

In some embodiments, the parameter state comprising the second DL RS is determined based on at least one of: a hybrid automatic repeat request acknowledge, HARQ-Ack, message corresponding a PDSCH carrying a MAC-CE command which activates the parameter state comprising the second DL RS, a RS transmission occasion, or DL control information triggering the transmission of the second DL RS.

In some embodiments, the third QCL type parameter comprises a Doppler shift.

In some embodiments, a frequency offset parameter is configured or activated for the DL signal, for the second DL RS or for a parameter state comprising the second DL RS, and wherein the DL signal is further received according to the frequency offset parameter.

In some embodiments, the frequency offset parameter is associated with a time stamp or a time-domain step.

In some embodiments, one of the at least one fourth parameter state is associated with a time stamp or a time-domain step.

In some embodiments, the time stamp or the time-domain step can be configured by an RRC signaling or a MAC-CE command.

In some embodiments, the parameter state is a quasi-co-location, QCL, state, a transmission configuration indicator, TCI, state, spatial relation information, a RS, a reference RS, a physical random access channel, PRACH, a spatial filter or a pre-coding.

The present disclosure relates to a wireless communication method for use in a wireless network node. the wireless communication method comprises: transmitting, to a wireless terminal, a downlink, DL, signal, wherein the DL signal is associated with at least one fourth parameter state, and wherein at least one of the at least one fourth parameter state comprises at least one second DL reference signal, RS, with regard to a first quasi-co-location, QCL, type parameter.

Various embodiments may implement the following features:

In some embodiments, the first QCL type parameter comprises a Doppler shift.

In some embodiments, a frequency offset parameter between the DL signal and the at least one second DL RS is configured by an RRC signaling or a MAC-CE command.

In some embodiments, at least one third DL RS, which is in the at least one fourth parameter state and is not associated with a UL signal, is ignored with regard to the first QCL type parameter.

In some embodiments, the second DL RS is associated with the UL signal.

In some embodiments, the first QCL type parameter is QCL-TYPEA, QCL-TYPEB or QCL-TYPEC.

In some embodiments, one of the at least one fourth parameter state further comprises a third DL RS with regard to a second QCL type parameter, wherein the second QCL type parameter does not comprise a Doppler shift and comprises a Doppler spread.

In some embodiments, the second QCL type parameter further comprises at least one of an average delay or a delay spread.

In some embodiments, the first QCL type parameter comprises the Doppler spread and the Doppler shift.

In some embodiments, the second DL RS is configured with a physical cell index and a reference RS with regard to a third QCL type parameter.

In some embodiments, the second DL RS is configured with a fifth parameter state, and wherein the fifth parameter state comprises a physical cell index and a reference RS with regard to a third QCL type parameter.

In some embodiments, a parameter state comprising the second DL RS is activated with a sixth parameter state which comprises a reference RS with regard to a third QCL type parameter.

In some embodiments, a QCL assumption of the second DL RS is determined according to the sixth parameter state, or the sixth parameter state is applied to the second DL RS.

In some embodiments, the parameter state comprising the second DL RS is activated for a physical DL control channel, PDCCH, a physical DL shared channel, PDSCH, a physical UL control channel, PUCCH, or a physical UL shared channel, PUSCH.

In some embodiments, the parameter state comprising the second DL RS is determined based on at least one of: a hybrid automatic repeat request acknowledge, HARQ-Ack, message corresponding a PDSCH carrying a MAC-CE command which activates the parameter state comprising the second DL RS, a RS transmission occasion, or DL control information triggering the transmission of the second DL RS.

In some embodiments, the third QCL type parameter comprises a Doppler shift.

In some embodiments, a frequency offset parameter is configured or activated for the DL signal, for the second DL RS or for a parameter state comprising the second DL RS, and wherein the DL signal is further transmitted according to the frequency offset parameter.

In some embodiments, the frequency offset parameter is associated with a time stamp or a time-domain step.

In some embodiments, one of the at least one fourth parameter state is associated with a time stamp or a time-domain step.

In some embodiments, the time stamp or the time-domain step can be configured by an RRC signaling or a MAC-CE command.

In some embodiments, the parameter state is a quasi-co-location, QCL, state, a transmission configuration indicator, TCI, state, spatial relation information, a RS, a reference RS, a physical random access channel, PRACH, a spatial filter or a pre-coding.

The present disclosure relates to a wireless terminal, comprising: a communication unit, configured to: transmit an uplink, UL, signal, wherein, based on an event associated with a first downlink, DL, reference signal, RS, the UL signal is modulated according to a specific carrier frequency.

Various embodiments may implement the following feature:

In some embodiments, the wireless terminal further comprises a processor configured to perform any of the aforementioned wireless communication methods for the wireless terminal.

The present disclosure relates to a wireless network node, comprising: a communication unit, configured to: transmit, to a wireless terminal, a first downlink, DL, reference signal, RS, and receive, from the wireless terminal, an uplink, UL, signal, wherein, based on an event associated with the first DL RS, the UL signal is modulated according to a specific carrier frequency.

Various embodiments may implement the following feature:

In some embodiments, the wireless network node further comprises a processor configured to perform any of the aforementioned wireless communication methods for the wireless network node.

The present disclosure relates to a wireless terminal, comprising: a communication unit, configured to: receive a downlink, DL, signal, wherein the DL signal is associated with at least one fourth parameter state, and wherein at least one of the at least one fourth parameter state comprises at least one second DL reference signal, RS, with regard to a first quasi-co-location, QCL, type parameter.

Various embodiments may implement the following feature:

In some embodiments, the wireless terminal further comprises a processor configured to perform any of the aforementioned wireless communication methods for the wireless terminal.

The present disclosure relates to a wireless network node, comprising: a communication unit, configured to: transmit, to a wireless terminal, a downlink, DL, signal, wherein the DL signal is associated with at least one fourth parameter state, and wherein at least one of the at least one fourth parameter state comprises at least one second DL reference signal, RS, with regard to a first quasi-co-location, QCL, type parameter.

Various embodiments may implement the following feature:

In some embodiments, the wireless network node further comprises a processor configured to perform any of the aforementioned wireless communication methods for the wireless network node.

The present disclosure relates to a computer program product comprising a computer-readable program medium code stored thereupon, the code, when executed by a processor, causing the processor to implement the aforementioned wireless communication method.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows an example of a high speed train scenario.

FIG. 2 shows an example of a schematic diagram of a wireless terminal according to an embodiment of the present disclosure.

FIG. 3 shows an example of a schematic diagram of a wireless network node according to an embodiment of the present disclosure.

FIG. 4 shows an example of Doppler shifts in introduced by the high speed movement of the HST according to an embodiment of the present disclosure.

FIG. 5 shows an example of pre-compensating the carrier frequencies of the DL signals from different TRPs/RRHs according to an embodiment of the present disclosure.

FIG. 6 shows an example of a frequency pre-compensation procedure in the SFN according to an embodiment of the present disclosure.

FIG. 7 shows an example of a frequency pre-compensation procedure in the SFN according to an embodiment of the present disclosure.

FIG. 8 shows an example for dynamic TRS configuration for frequency tracking according to an embodiment of the present disclosure.

FIG. 9 shows an example of time-domain pattern configuration for parameter state(s) with time domain step(s) according to an embodiment of the present disclosure.

FIG. 10 shows an example of time-domain pattern configuration for time stamps according to an embodiment of the present disclosure.

### DETAILED DESCRIPTION

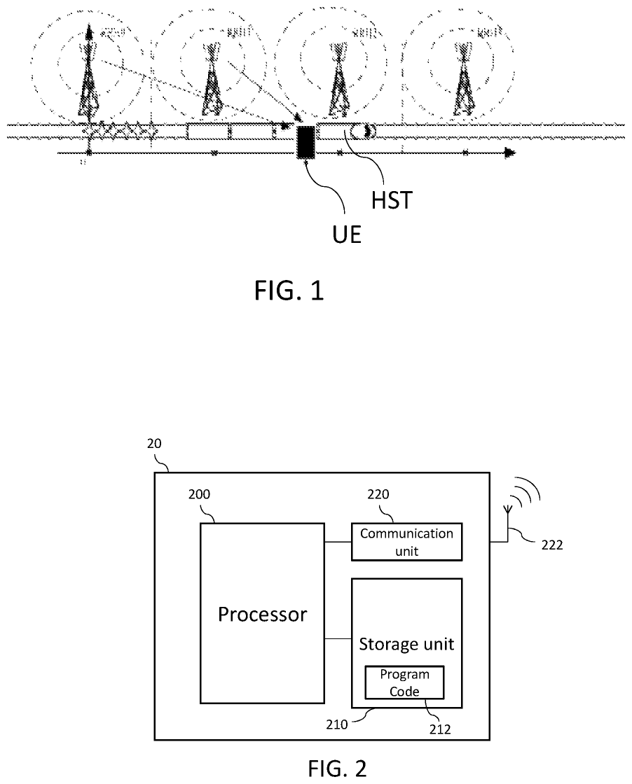

In the HST scenario, a speed of a train may be up to 350 km/h or even more. The communication performance for a UE becomes a serious issue in the HST. As usual, the operator shall deploy many gNBs along with the HST railway. The handover between gNBs is complex, and meanwhile, considering the fast movement of the HST, there are several TRPs/RRHs belonging to a SFN, as shown in FIG. 1. From UE perspective, there is no cell-level mobility/handover when the UE passes through the SFN.

In FIG. 1, several TRPs/RRHs (e.g. RRHs RRH0, RRH1, RRH2 and RRH3) simultaneously transmit a downlink (DL) signal to a UE in the SFN. Since the UE may experience different fading for signals from different TRPs/RRHs, the UE may accordingly obtain significant diversity gains.

However, there are different Doppler shifts between each of different TRPs/RRHs and a UE. Moreover, when the TRPs/RRHs have the same center frequency, the center frequency of the DL signal respectively from each of the TRPs/RRHs can be different from the UE perspective. Under such a condition, serious inter-symbol interference (ISI) may occur for neighboring subcarriers in orthogonal frequency-division multiplexing (OFDM).

FIG. 2 relates to a schematic diagram of a wireless terminal 20 according to an embodiment of the present disclosure. The wireless terminal 20 may be a user equipment (UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 212 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g. messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g. a base station).

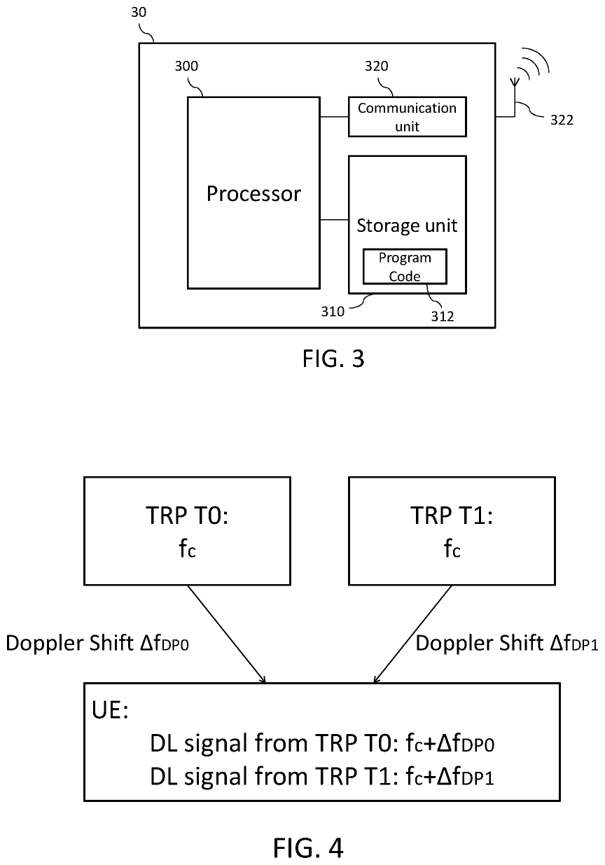

FIG. 3 relates to a schematic diagram of a wireless network node 30 according to an embodiment of the present disclosure. The wireless network node 30 may be a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 312 include but are not limited to a SIM, ROM, flash memory, RAM, hard-disk, and optical data storage device. The communication unit 320 may be a transceiver and is used to transmit and receive signals (e.g. messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g. a user equipment).

In this disclosure, the definition of “parameter state” is equivalent to quasi-co-location (QCL) state, transmission configuration indicator (TCI) state, spatial relation (also called as spatial relation information), reference signal (RS), reference RS, physical random access channel (PRACH)), spatial filter or pre-coding.

Specifically:

The definition of “parameter state identification” is equivalent to QCL state index, TCI state index, spatial relation index, reference signal index, spatial filter index or precoding index.

The RS comprises channel state information reference signal (CSI-RS), synchronization signal block (SSB) (which is also called as SS/PBCH), demodulation reference signal (DMRS), sounding reference signal (SRS), or physical random access channel (PRACH)).

Specifically, the spatial filter can be either UE-side or gNB-side one and the spatial filter is also called spatial-domain filter.

Note that, in this disclosure, “spatial relation information” is comprised of one or more reference RSs, which is used to represent the same or quasi-co “spatial relation” between targeted “RS or channel” and the one or more reference RSs.

Note that, in this disclosure, “spatial relation” means the beam, spatial parameter, or spatial domain filter.

Note that, in this disclosure, “QCL state” is comprised of one or more reference RSs and their corresponding QCL type parameters, where QCL type parameters include at least one of the following aspect or combination: [1] Doppler spread, [2] Doppler shift, [3] delay spread, [4] average delay, [5] average gain, and [6] Spatial parameter (which is also called as spatial Rx parameter). In this disclosure, “TCI state” is equivalent to “QCL state”. In this disclosure, there are the following definitions for ‘QCL-TypeA’, ‘QCL-TypeB’, ‘QCL-TypeC’, and ‘QCL-TypeD’.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Note that, in this disclosure, “UL signal” (i.e. uplink signal) can be physical UL control channel (PUCCH), physical UL shared channel (PUSCH), PRACH, or SRS.

Note that, in this disclosure, “DL signal” (i.e. downlink signal) can be physical DL control channel (PDCCH), physical DL shared channel (PDSCH) or CSI-RS.

Note that, in this disclosure, “DL RS” (i.e. downlink reference signal) can be DMRS, SSB, SS/PBCH, CSI-RS, or CSI-RS for tracking (which is also called as tracking RS (TRS)).

Note that, in this disclosure, “UL RS” (i.e. uplink reference signal) can be DMRS, PRACH or SRS.

Note that, in this disclosure, “time unit” can be sub-symbol, symbol, slot, sub-frame, frame, or transmission occasion.

Note that, in this disclosure, “frequency offset” can be Doppler shift offset or Doppler offset.

Note that, in this disclosure, “frequency offset parameter” can be Doppler shift offset parameter, or Doppler offset parameter.

The speed of HST may be up to 350 km/hour and which may increase to 500 km/hour or more in the future. Thus, Doppler shifts introduced by the high speed movement of the HST become a serious issue for the wireless communication performance (e.g. serious inter-subcarrier interference (ISI)). FIG. 4 shows an example of the Doppler shifts introduced by the high speed movement of the HST according to an embodiment of the present disclosure. In FIG. 4, both TRPs T0 and T1 (e.g. RRHs RRH0 and RRH1 shown in FIG. 1) transmits DL signals with a center frequency f_{c} to a UE. Because a Doppler shift Δf_{DP0} between the TRP T0 and the UE is different from a Doppler shift Δf_{DP1} between the TRP T1 and the UE, the UE (e.g. a DL receiver of the UE) may receive the DL signals with a center frequency f_{c}+Δf_{DP0} from the TRP T0 and receive the DL signals with a center frequency f_{c}+Δf_{DP1} from the TRP T1.

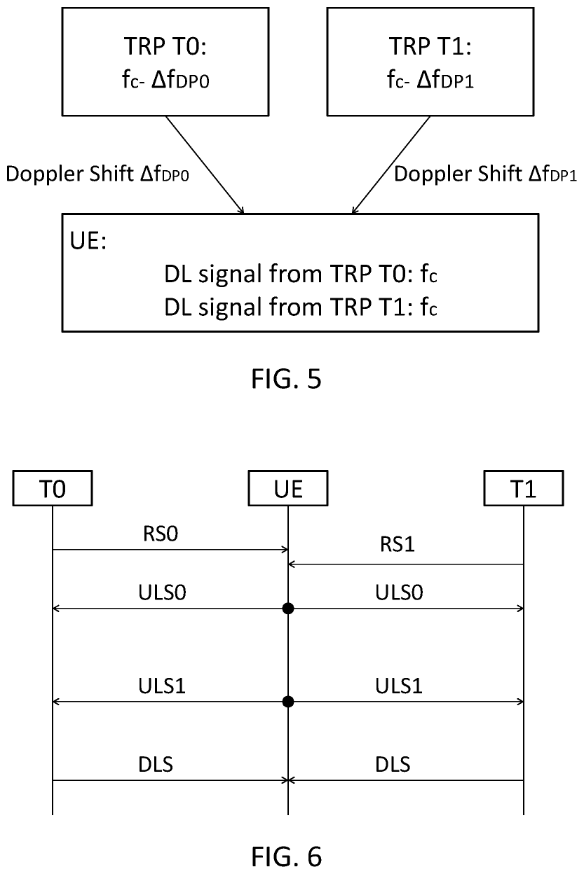

In order to eliminate the ISI, each of the TRPs/RRHs may pre-compensate the central carrier frequency point (which can be called as a carrier frequency for brevity) of its DL signal based on the respective Doppler shifts, and, from UE perspective, the carrier frequencies of the DL signals from different TRPs/RRHs may be the same or aligned after affected by the Doppler shifts in reality. FIG. 5 shows an example of pre-compensating the carrier frequencies of the DL signals from different TRPs/RRHs according to an embodiment of the present disclosure. In FIG. 5, the TRP T0 transmits a DL signal with a center frequency f−Δf_{DP0} to the UE and the TRP T1 transmits a DL signal with a center frequency f_{c}-Δf_{DP1} to the UE. Due to the Doppler shifts, the carrier frequencies of the DL signals received from both the TRPs T0 and T1 become the same/aligned in the UE perspective.

When the TRPs pre-compensate the carrier frequency, some potential issues may need to be discussed. In the following, potential issues of pre-compensating the carrier frequency are exemplified for illustrations:

1. A reference RS indication for UL transmission may need to be considered. In order to estimate the Doppler shifts corresponding to the TRP/RRH (rather than a mixed value of the Doppler shift between the TRP/RRH and UE and a frequency offset introduced by local oscillator of the UE), a reference RS from a TRP may be indicated, so as to make a carrier frequency of subsequent UL transmissions aligned with that of the reference RS received by the UE.

2. Taking into account that the HST passes through the several TRPs/RRHs in an order, a semi-persistent or an aperiodic tracking RS (TRS, also called as CSI-RS for tracking) may be an option. For instance, when the UE gets close to one new TRP, the new TRP may accordingly activate a corresponding TRS and deactivate a previous TRS.

3. Whether or when the frequency pre-compensation is applied for a DL or UL transmission should be aligned for both gNB and UE sides. If the TRP/RRH and the UE follow a unique frequency pre-compensation for all of DL and UL transmissions in a given period, the TRS should be UE specific rather than cell specific. Consequently, the whole RS overhead may be very large from the system perspective.

4. QCL/QCL-like relation (including applicable type(s) and the associated requirement) between the DL signal and the UL signal may need to be considered for the frequency pre-compensation. As mentioned before, there may be some gaps between a reference RS and a target RS in center frequency, and corresponding definitions for this association between the reference RS and the target RS should be specified.

In an embodiment, a new framework for frequency pre-compensation parameter indication and new parameter definition is introduced for the frequency pre-compensation.

When the UE receives a DL signal transmitted from a TRP, the frequency offset between UE and the TRP in the received DL signal is determined according to the Doppler shift and a carrier frequency offset (also called as center frequency offset) between the carrier frequencies of the UE and the TRP (e.g. caused by the oscillators of the UE and the TRP). Under such a condition, the UE cannot estimate the Doppler shift separately. In order to estimate the Doppler shift, the UE may modulate a carrier frequency of a UL signal within an accurate scope (e.g., ±0.1 PPM observed over a period of 1 ms) compared to the carrier frequency of the DL signal received from the TRP. As a result, when the TRP receives this UL signal, the carrier frequency offset between the UE and the TRP center frequency is withdrawn and the Doppler shift between the UE and TRP is doubled in the UL signal. The TRP therefore can estimate the Doppler shift between the UE and the TRP according to the carrier frequency offset between the carrier frequencies of the received UL signal and local carrier frequency (e.g., doubled Doppler shift).

In an embodiment, a UL signal may be associated with a DL RS with regard to a carrier frequency or a Doppler shift. In other words, the UL signal is associated with the DL RS for measuring the carrier frequency or the Doppler shift (e.g. for subsequent UL/DL communications). In this embodiment, the UL signal is modulated according to a carrier frequency of the DL RS. For example, a carrier frequency of the UL signal may be modulated according to the carrier frequency of the DL RS. Furthermore, the DL RS is received T1 time units before or no later than the UL signal transmission or the command scheduling the UL signal transmission, wherein T1 is an integer. Furthermore, at least X1 samples of DL RS are received before or no later than the UL signal transmission or the command scheduling the UL signal transmission, wherein X1 is an integer.

In an embodiment, the applicable time for the carrier frequency of DL RS is T2 time unit after an event, wherein the applicable time is determined according to a command associated with (e.g. activating) the DL RS, a command associated with (e.g. activating) a parameter state comprising the first DL RS or the X2 samples of the DL RS, wherein T2 and X2 are integers. For instance, the applicable time for the carrier frequency of DL RS is T2 time units after X2 samples of the DL RS from the time instance of 3 ms after sending hybrid automatic repeat request acknowledge, HARQ-ACK, message corresponding to the PDSCH carrying the command activating the DL RS. Furthermore, the command is a MAC-CE command.

In an embodiment, a previous carrier frequency may be reused before the applicable time that is the T3 time units after an event that is determined according to a command activating the DL RS or the X3 samples of the DL RS, where T3 and X3 are integers. For example, the previous carrier frequency may be the most recently used carrier frequency of the UE or the latest carrier frequency used by the UE.

In an embodiment, when the UE is indicated that the carrier frequency for the UL signal does not refer to any DL RS or refers to a local carrier frequency, or that the DL RS is not configured, the UL signal (e.g. a carrier frequency of the UL signal) may be modulated according to the local carrier frequency or a carrier frequency of the UE.

In an embodiment, the UE modulates the carrier frequency of the UL signal within ±0.1 PPM observed over a period of 1 ms compared to the carrier frequency of the received DL RS.

In an aspect, how to determine the DL RS associated with the UL signal is a topic to be discussed.

In an embodiment, the DL RS associated with the UL signal is determined according to a parameter state applied to the UL signal. For example, the DL RS associated with the UL signal is a reference RS in the parameter state applied to the UL signal, where the reference RS is related to at least one of the carrier frequency or the Doppler shift. In an embodiment, the DL RS is associated with a QCL type parameter comprising at least one of the carrier frequency or the Doppler shift. In an embodiment, the DL RS is associated with QCL-TypeA, QCL-TypeB or QCL-TypeC.

In an embodiment, the DL RS associated with the UL signal is configured by a radio resource control (RRC) signaling or activated by a media access control control element (MAC-CE) command. For example, the DL RS is configured or activated for a cell (e.g. the RRC signaling configures the DL RS for the cell, or the MAC-CE command activates the DL RS for the cell), in which the transmission or carrier frequency determination of a UL signal is determined according to the DL RS. Furthermore, the definition of “cell” is equivalent to carrier component.

In an embodiment, for physical UL control channel (PUCCH), the DL RS associated with the UL signal is configured in an RRC parameter PUCCH configuration signaling (i.e. PUCCH-Config) or configured for a PUCCH resource, a PUCCH resource group or a PUCCH resource set.

In an embodiment, for a PUSCH, the DL RS associated with the UL signal is configured in an RRC parameter PUSCH configuration signaling (i.e. PUSCH-Config).

In an embodiment, for an SRS, the DL RS associated with the UL signal is configured in an RRC parameter SRS configuration signaling (i.e. SRS-Config), or configured for an SRS resource or SRS resource set.

In an embodiment, the DL RS associated with the UL signal is a CSI-RS for tracking, which is also called as TRS.

In an embodiment, for a subsequent DL transmission from different TRPs, a parameter related to the frequency pre-compensation may be configured or specified.

In an embodiment, a DL signal of the subsequent DL transmission may be associated with two or more reference parameter states with regard to a QCL type parameter (e.g., comprising the carrier frequency or the Doppler shift). In an embodiment, the two associated reference parameter states comprise two reference DL RSs with regard to the QCL type parameter. In an embodiment, a frequency offset parameter between the DL signal and at least one of the reference DL RSs may be configured by an RRC signaling or activated by a MAC-CE command. In an embodiment, within the two configured reference DL RSs, the reference DL RS that is not associated with a (previous) UL signal is ignored with regard to the QCL type parameter (e.g. comprising the carrier frequency or the Doppler shift). In an embodiment, the DL RS associated with the (previous) UL signal is used for determining the QCL type parameter (e.g. comprising the carrier frequency or the Doppler shift) for the subsequent DL transmission. In an embodiment, the QCL type parameter may be QCL-TypeA, QCL-TypeB, or QCL-TypeC.

In an embodiment, a DL signal of the subsequent DL transmission may be associated only one reference parameter state with regard to a QCL type parameter comprising the Doppler shift. For example, the associated reference parameter state may comprise a reference DL RS with regard to the QCL type parameter comprising the Doppler shift. In this embodiment, the carrier frequency of signaling (e.g. DL signal) transmitting from the other serving TRP (rather than the TRP transmitting the only one reference DL RS with regard to the QCL type parameter comprising the Doppler shift) should be pre-compensated and aligned with the reference DL RS from UE perspective. In an embodiment, the DL signal may be associated with a new QCL type parameter including a Doppler spread but does not include the Doppler shift (e.g., QCL-TypeE: {Doppler spread}). In an embodiment, the new QCL type parameter may further comprise at least one of average delay or delay spread. For example, the new QCL type parameter may be QCL-TypeE which represents one of {Doppler spread}, {Doppler spread, average delay}, {Doppler spread, average spread} or {Doppler spread, average delay, delay spread}. In an embodiment, the DL signal is associated with a parameter state that includes two reference DL RSs for the Doppler spread but include only one reference DL RS for the Doppler shift. In this embodiment, the Doppler shift may be determined according to the only one reference DL RS for the Doppler shift and the Doppler spread may be determined according to the both of two reference DL RSs for the Doppler spread.

FIG. 6 shows an example of a frequency pre-compensation procedure in the SFN according to an embodiment of the present disclosure. In FIG. 6, there are two TRPs T0 and T1 (e.g. the RRHs RRH0 and RRH1 shown in FIG. 1) serving a UE in the SFN, wherein carry frequencies of the TRPs T0 and T1 are both a frequency L. Note that, the TRPs T0 and T1 have different local frequency offsets (also called as carrier frequency errors). In this embodiment, a frequency offset Δf_{OC_T0_T1} denotes a carrier frequency offset between the local frequency offsets of the TRPs T0 and T1. In addition, a frequency offset Δf_{OC_T0_UE} denotes a carrier frequency difference between the carrier frequencies of the TRP T0 and the UE, a frequency difference Δf_{OC_T1_UE} denotes a carrier frequency difference between the carrier frequencies of the TRP T1 and the UE, a frequency offset Δf_{DP0} denotes a Doppler shift from the TRP T0 to the UE and a frequency offset Δf_{DP1} denotes a Doppler shift from the TRP T1 to the UE.

In FIG. 6, the TRP T0 transmits a reference DL RS RS0 to the UE and the carrier frequency of the reference DL RS RS0 from the UE perspective (e.g. the carrier frequency of the reference DL RS RS0 received by the UE) can be expressed as:

f_{c}+Δf_{DP0}+Δf_{OC_T0_UE}

Similarly, the TRP T1 transmits a reference DL RS RS1 to the UE and the carrier frequency of the reference DL RS RS1 from the UE perspective (e.g. the carrier frequency of the reference DL RS RS1 received by the UE) can be expressed as:

f_{c}+Δf_{DP1}+Δf_{OC_T1_UE}

Next, the UE transmits a UL signal ULS0 (e.g. PUSCH or SRS) to both the TRPs T0 and T1. Note that, the UL signal ULS0 is modulated with the carrier frequency of the DL RS RS0 (i.e. f_{c}+Δf_{DP0}+Δf_{OC_T0_UE}).

From the TRP T0 perspective, the carrier frequency of UL signal ULS0 becomes f_{c}+20f_{DP0} because the frequency offset Δf_{OC_T0_UE} between the carrier frequencies of the UE and the TRP T0 is withdrawn. Under such a condition, the TRP T0 is able to estimate the frequency offset Δf_{DP0}.

From the TRP T1 perspective, the carrier frequency of UL signal ULS0 is f_{c}+Δf_{DP0}+Δf_{DP1}+Δf_{OC_T0_T1}. In an embodiment, the frequency offsets Δf_{DP0} and Δf_{OC_T0_T1} are known in the TRP T1 because the TRP T1 may be indicated (e.g. configured) the frequency offset Δf_{DP0} estimated in the TRP T0 and may estimate the frequency offset Δf_{OC_T0_T1} by tracking TRS of the TRP T1 (or the TRPs T0 and T1 are synchronized by a dedicated fiber). Thus, the frequency offset Δf_{DP1} can be estimated accordingly.

The UE further transmits a UL signal ULS1 (e.g. PRACH or SRS) to both the TRPs T0 and T1, wherein the UL signal ULS1 is modulated with a local carrier frequency (e.g. the carrier frequency f_{c} of the TRP T0).

From the TRP T0 perspective, the carrier frequency of UL signal ULS1 is f_{c}+Δf_{DP0}+Δf_{OC_T0_UE}. Since the frequency offset Δf_{DP0} is estimated based on the UL signal ULS0, the frequency offset Δf_{OC_T0_UE} can be estimated, e.g., by the TRP T0.

From the TRP T1 perspective, the carrier frequency of UL signal ULS1 is f_{c}+Δf_{DP1}+Δf_{OC_T1_UE}. Because the frequency offset Δf_{DP1} is estimated based on the UL signal ULS0, the frequency offset Δf_{OC_T1_UE} can be estimated, e.g., by the TRP T1.

According to the estimated frequency offsets Δf_{DP0}, Δf_{DP1}, Δf_{OC_T0_UE} and Δf_{OC_T1_UE}, a DL communication (e.g. DL signal DLS) from the TRPs T0 and T1 is able to be pre-compensated. In an embodiment, the DL signal is PDSCH. In an example, the carrier frequency of the DL signal DLS from the TRP T0 is pre-compensated to f_{c}−Δf_{DP0}−Δf_{OC_T0_UE} and the carrier frequency of the DL signal DLS from the TRP T1 is pre-compensated to f_{c}−Δf_{DP1}−Δf_{OC_T1_UE} Via the pre-compensations, the DL transmission from the TRPs T0 and T1 is aligned with the local carrier frequency of the UE (i.e. the carrier frequency f_{c}). As a result, the inter-subcarrier interference caused by different Doppler shifts can be eliminated, e.g., when the UE receives the DL signal DLS in the SFN. Furthermore, the DMRS of the DL transmission may be quasi-co-located with both the reference DL RSs RS0 and RS1 with regard to Doppler shift.

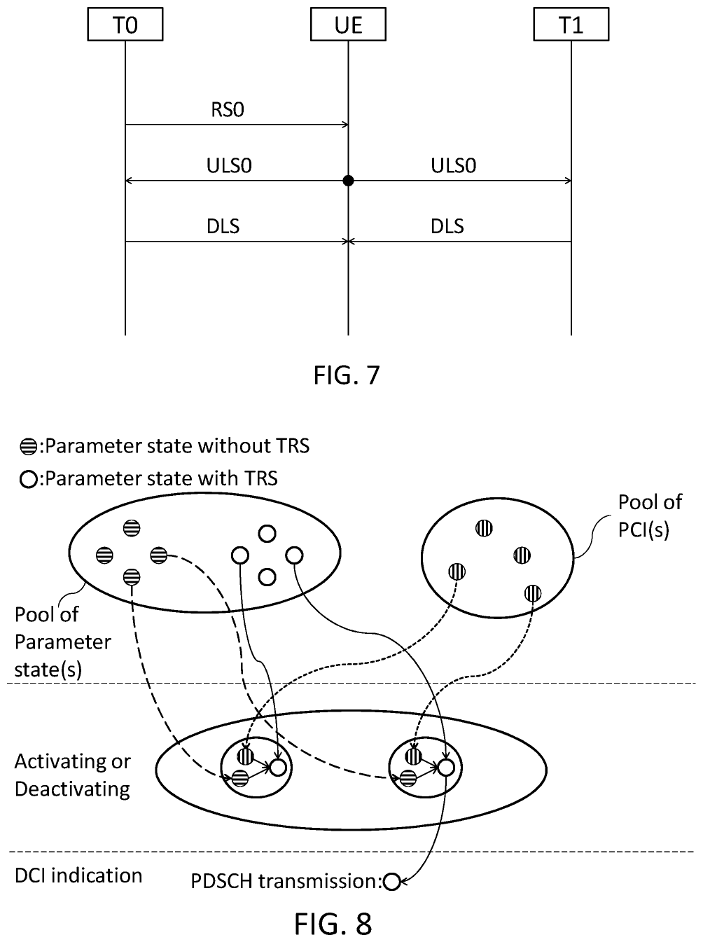

FIG. 7 shows an example of a frequency pre-compensation procedure in the SFN according to an embodiment of the present disclosure. The embodiment shown in FIG. 7 may be similar to that shown in FIG. 6, thus the signals and the components with similar functions use the same symbols. In FIG. 7, there are two TRPs T0 and T1 (e.g. the RRHs RRH0 and RRH1 shown in FIG. 1) serving a UE in the SFN, wherein carry frequencies of the TRPs T0 and T1 are both a frequency f_{c}. Note that, the TRPs T0 and T1 have different local frequency offsets. In this embodiment, a frequency offset Δf_{OC_T0_T1} denotes a carrier frequency offset between the local frequency offsets of the TRPs T0 and T1. In addition, a frequency offset Δf_{OC_T0_UE} denotes a carrier frequency difference between the carrier frequencies of the TRP T0 and the UE, a frequency difference Δf_{OC_T1_UE} denotes a carrier frequency difference between the carrier frequencies of the TRP T1 and the UE, a frequency offset Δf_{DP0} denotes a Doppler shift from the TRP T0 to the UE and a frequency offset Δf_{DP1} denotes a Doppler shift from the TRP T1 to the UE.

In FIG. 7, the TRP T0 transmits a reference DL RS RS0 to the UE and the carrier frequency of the reference DL RS RS0 from the UE perspective (e.g. the carrier frequency of the reference DL RS RS0 received by the UE) can be expressed as:

f_{c}+Δf_{DP0}+Δf_{OC_T0_UE}

Note that, the TRP T1 does not transmit a reference DL RS to the UE, e.g., with regard to the Doppler shift.

Next, the UE transmits a UL signal ULS0 (e.g. PUSCH or SRS) to both the TRPs T0 and T1. Note that, the UL signal ULS0 is modulated with the carrier frequency of the DL RS RS0 (i.e. f_{c}+Δf_{DP0}+Δf_{OC_T0_UE}).

From the TRP T0 perspective, the carrier frequency of UL signal ULS0 becomes f_{c}+2Δf_{DP0} because the frequency offset Δf_{OC_T0_UE} between the carrier frequencies of the UE and the TRP T0 is withdrawn. Under such a condition, the TRP T0 is able to estimate the frequency offset Δf_{DP0}.

From the TRP T1 perspective, the carrier frequency of UL signal ULS0 is f_{c}+Δf_{DP0}+Δf_{DP1}+Δf_{OC_T0_T1}. In an embodiment, the frequency offsets Δf_{DP0} and Δf_{OC_T0_T1} are known in the TRP T1, e.g., because the TRP T1 may be indicated the frequency offset Δf_{DP0} estimated in the TRP T0 and may estimate the frequency offset Δf_{OC_T0_T1} by tracking TRS of the TRP T1 (or the TRPs T0 and T1 are synchronized by a dedicated fiber). Thus, the frequency offset Δf_{DP1} can be estimated accordingly.

In the embodiment shown in FIG. 7, the UE does not further transmit a UL signal which is modulated with a local carrier frequency (e.g. the UL signal ULS1 shown in FIG. 6) to both the TRPs T0 and T1.

In FIG. 7, the DL communication (e.g. DL signal DLS) from the TRP T0 is not pre-compensated. That is, the TRP T0 transmits the DL signal DLS modulated with the frequency f_{c} to the UE. Besides, the DL communication (e.g. DL signal DLS) from the TRP T1 is pre-compensated according to the estimated frequency offsets Δf_{DP0}, Δf_{DP1} and Δf_{OC_T0_T1}. In an embodiment, the DL signal is PDSCH. In an embodiment, the carrier frequency of the DL signal DLS from the TRP T1 is pre-compensated to be f_{c}+Δf_{DP0}−Δf_{DP1}+Δf_{OC_T0_T1}. Via the pre-compensation, the DL transmission from the TRPs T0 and T1 is aligned with a carrier frequency f_{c}+Δf_{DP0}+Δf_{OC_T0_T1} from the UE perspective. As a result, the inter-subcarrier interference caused by different Doppler shifts can also be eliminated, e.g., when the UE receives the DL signal DLS in the SFN. Moreover, the DMRS of the DL transmission may be quasi-co-located with the reference DL RS RS0 with regard to the Doppler shift.

In order to achieve non-cell-level mobility/handover when the UE passes through the SFN, a TRS configuration for frequency tracking may need to be updated quickly, e.g., from the RRH RRH0 to the RRH RRH1 shown in FIG. 1. In a given time, the number of TRSs to be monitored or tracked by the UE is limited. However, from the SFN-system perspective, the total number of TRSs may be huge because there may be sufficient TRPs/RRHs. Therefore, a dynamic TRS configuration for frequency tracking may worth to be considered for the SFN-system.

In an embodiment, a TRS may be configured with a physical cell index and a reference RS with regard to a QCL type parameter by an RRC signaling or a MAC-CE command.

In an embodiment, the physical cell index may be utilized to indicate a neighboring cell for the TRS and the reference RS in the neighboring cell is assumed as the reference RS for the TRS with regard to the QCL type parameter. In an embodiment, the QCL type parameter may be a Doppler shift or a spatial parameter. In an embodiment, the reference RS is SSB.

In am embodiment, the TRS may be configured with a parameter state, which includes a physical cell index and a reference RS with regard to a QCL type parameter.

In an embodiment, the TRS may be semi-persistent and the semi-persistent TRS may be activated with a parameter state PS_A by a MAC-CE command. In this embodiment, another parameter state PS_B including the semi-persistent TRS is activated by the parameter state PS_A and the parameter state PS_B of the semi-persistent TRS (e.g. QCL assumption) is determined according to the parameter state PS_A or the state PS_A is applied to the TRS. In an embodiment, the parameter state PS_B can be indicated or activated for PDCCH or PDSCH transmissions.

In an embodiment, the TRS may be aperiodic. In an embodiment, the aperiodic TRS may be activated with a parameter state by a MAC-CE.

In an embodiment, the parameter state of the TRS is determined according to at least one of the following

1. A hybrid automatic repeat request acknowledge, HARQ-ACK, message corresponding to the PDSCH carrying the MAC-CE command that is utilized for activating the parameter state for the TRS;

2. A transmission occasion of the TRS; and

3. DCI triggering the transmission of the, e.g., when the TRS is aperiodic.

FIG. 8 shows an example for dynamic TRS configuration for frequency tracking according to an embodiment of the present disclosure. In FIG. 8, several parameter state(s) (e.g. TCI state(s)) are configured by an RRC signaling, wherein some of them are configured with a TRS as a reference RS with regard to a QCL type parameter (e.g. hollow circles shown in FIG. 8) and some of them are not configured with a TRS (e.g. circles with horizontal stripes shown in FIG. 8). In addition, multiple PCI(s) (e.g. circles with vertical stripes shown in FIG. 8) are configured as in a pool. In this embodiment, the TRS is not configured with a parameter state.

In FIG. 8, at least one of the parameter states with the TRS is activated by corresponding reference parameter state (e.g. one of the parameter states without the TRS) and corresponding PCI. In other words, the at least one parameter state (e.g. at least one QCL assumption) of the TRS is determined according to (e.g. associated with) the corresponding reference parameter state and the corresponding PCI.

In an embodiment of FIG. 8, one out of the at least one activated parameter state is indicated for the PDSCH transmission. For example, one of the at least one activated parameter state may be selected to be applied to the PDSCH transmission.

In an embodiment, the Doppler shift may be eliminated by using the method of frequency pre-compensation. In an embodiment, carrier frequencies for reference RS(s) and a target signal (e.g. the reference DL RS RS0 and the DL signal DLS from the TRP T0 shown in FIG. 6 or 7) may be able to be different. In an embodiment, a frequency offset configuration between the reference RS and the target signal may be performed and the UE may further compensate the frequency offset for the target signal when receiving (e.g. demodulating) the target signal. In an embodiment of adopting the frequency offset configuration between the reference RS (without frequency pre-compensation) and a DL transmission (e.g. PDSCH transmission, or DMRS of PDSCH transmission) (with frequency compensation), a cell-specific TRS, rather than a UE specific TRS, may be enabled in the SFN.

In an embodiment, a frequency offset parameter for a reference RS may be associated with a parameter state, e.g., by an RRC signaling or a MAC-CE command. In this embodiment, the reference RS may be the corresponding RS with regard to at least the Doppler shift or a specific RS in the parameter state. In an embodiment of the parameter state being applied for a target signal, the carrier frequency or the Doppler shift for the target signal is determined according to the reference RS and the frequency offset parameter. Note that, the frequency offset parameter is directly configured/associated with the parameter state in this embodiment.

In an embodiment, a frequency offset parameter is configured or activated for a reference RS by an RRC signaling or a MAC-CE command. In this embodiment, the frequency offset parameter is applied for a transmission of a target signal when the transmission of the target signal is determined according to the reference RS for which the frequency offset parameter is configured or activated. In this embodiment, the frequency offset parameter is not directly configured/associated with the parameter state.

In an embodiment of the target signal being a DL signal, the DL signal may be received, e.g. by the UE, according to the sum of a carrier frequency of the reference RS and a configured frequency offset (e.g. indicated by the frequency offset parameter). For example, one PDSCH transmission is indicated with a parameter state which includes a TRS with regard to the Doppler shift and a configured frequency offset (parameter). In the UE side, a frequency estimation for the TRS is 1.001 GHz, and the configured frequency offset is −0.002 GHz. Therefore, the UE assumes the carrier frequency for the PDSCH transmission is 0.999 GHz, which is used for the subsequent demodulation(s).

In an embodiment of the target signal being a UL signal, the UL signal may be modulated with the carrier frequency that is determined according to the carrier frequency of the reference RS and a configured frequency offset (e.g. indicated by the frequency offset parameter). For instance, one SRS transmission is indicated with a parameter state which includes a TRS as a reference RS for the frequency pre-compensation and a configured frequency offset (parameter). In the UE side, the carrier frequency estimation for the TRS is 1.000 GHz, and the configured frequency offset is −0.002 GHz. Under such a condition, the carrier frequency modulated for the SRS transmission may be 0.998 GHz. In this embodiment, the error for the real carrier frequency for the SRS transmission may need to be within a scope.

In an embodiment, the target signal may be a DL RS, a DL data channel (e.g., PDSCH) and/or a DL control channel (e.g., PDCCH).

In an embodiment, the target signal may be a UL RS, a UL data channel (e.g., PUSCH) and/or a UL control channel (e.g., PUCCH).

In the HST scenario, a moving path and a moving speed of a UE (one the HST) may be stable. Thus, a frequency offset parameter and/or a reference RS with regard to at least one of the Doppler shift or the carrier frequency may be pre-determined. That is, a time-domain pattern for the frequency offset parameter and/or the reference RS may be configured, to reduce signaling overhead and to improve transmission performance through utilizing a time-domain continuous pre-compensation.

In an embodiment, a set of frequency offset parameters, parameter state(s), and/or reference RS(s) is configured, and one of the set of frequency offset parameters, parameter state(s), and/or a reference RS is associated with a timestamp and/or a time-domain step. In an embodiment, a step between two neighboring (e.g. adjacent) timestamps can be configurable or pre-defined (e.g., 10 ms). In an embodiment, the starting point for timestamp is determined according to at least one of the following:

1. The HARQ-ACK message corresponding to the PDSCH carrying the MAC-CE command that activates the configuration e.g., activating the associated parameter state;

2. The PDSCH carrying the MAC-CE command that activates the configuration, e.g., activating the associated parameter state; and

3. The DCI triggering the command for frequency offset parameter or reference RS configuration.

In an embodiment, the timestamp is configurable. In other words, an offset from receiving the corresponding command or transmitting the HARQ-ACK for the corresponding command to the time point of adopting the pre-configured frequency offset parameter, parameter state and/or the pre-configured reference RS may be configured.

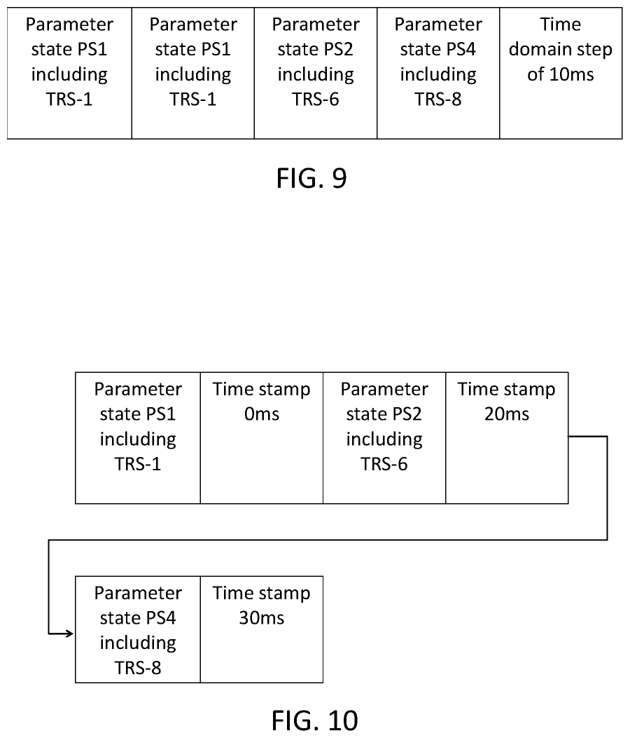

FIG. 9 shows an example of time-domain pattern configuration for parameter state(s) with time domain step(s) according to an embodiment of the present disclosure, wherein the parameter state(s) (e.g. parameter states PS1, PS2 and PS4) include the reference RS(s) with regard to at least one of the Doppler shift or the carrier frequency. In FIG. 9, the time domain step is explicitly configured as 10 ms and parameter states PS1, PS1, PS2 and PS4 are applied for a PDSCH transmission starting from 0 ms, 10 ms, 20 ms and 30 ms, respectively.

FIG. 10 shows an example of time-domain pattern configuration for time stamps according to an embodiment of the present disclosure, wherein the parameter state(s) (e.g. parameter states PS1, PS2 and PS4) include the reference RS(s) with regard to at least one of the Doppler shift or the carrier frequency. In FIG. 10, the timestamps(s) is configured per parameter state. For example, the parameter state PS1 including a TRS TRS-1 is applied for a PDSCH transmission starting from a timestamp of 0 ms, the parameter state PS2 including a TRS TRS-6 is applied for the PDSCH transmission starting from a timestamp of 20 ms and the parameter state PS4 including a TRS TRS-8 is applied for the PDSCH transmission starting from a timestamp of 30 ms.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method for use in a wireless terminal, comprising:
transmitting an uplink (UL) signal, wherein, based on an event associated with a first downlink (DL) reference signal (RS), the UL signal is modulated according to a specific carrier frequency.
